(19) United States
(12) Patent Application Publication
(10) Pub. No.: US 2009/0089265 A1
(43) Pub. Date: Apr. 2, 2009

(54) INFORMATION PROCESSING APPARATUS, INFORMATION PROCESSING METHOD, AND PROGRAM

(76) Inventors: Mari SAITO, Kanagawa (JP); Noriyuki YAMAMOTO, Kanagawa (JP); Tomohiro TSUNODA, Tokyo (JP)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 12/327,537

(22) Filed: Dec. 3, 2008

(30) Foreign Application Priority Data
Apr. 12, 2007 (JP) P2007-313097

(51) Int. Cl. G06F 7/06; G06F 17/30

(52) U.S. Cl. 707/3; 707/E17.014

(57) ABSTRACT

An information processing apparatus includes: a analysis mechanism obtaining a relationship between items pertaining to individually different fields on the basis of a user's evaluation on the individual items; a setting mechanism setting relationship information being information indicating the relationship obtained by an analysis of the analysis mechanism for individual items as meta data; and on the basis of the relationship information set by the setting mechanism for a predetermined item to be a reference, a recommendation mechanism identifying, as a recommendation item, an item pertaining to a different field from a field including the predetermined item having a relationship with the predetermined item.

### CROSS REFERENCES TO RELATED APPLICATIONS

The present invention contains subject matter related to Japanese Patent Application JP 2007-313097 filed in the Japanese Patent Office on Dec. 4, 2007, the entire contents of which are incorporated herein by reference.

### BACKGROUND OF THE INVENTION

1. Field of the Invention

The present invention relates to an information processing apparatus, an information processing method, and a program. More particularly, the present invention relates to an information processing apparatus, an information processing method, and a program which make it possible to obtain relationships among items on the basis of a user's evaluation, and to recommend an item across fields.

2. Description of the Related Art

In recent years, Web services for recommending an item pertaining to a different field from a field including an item to be a reference have been provided. For example, when a cookbook is selected, a cooking pan newly produced is recommended accordingly.

Japanese Unexamined Patent Application Publication No. 2007-115222

### SUMMARY OF THE INVENTION

Such a service as recommending an item across fields is usually implemented by a rule-base system in which recommendation rules are determined in advance, or is implemented by collaborative filtering on the basis of histories of a large number of users, such as purchase histories, etc.

In the latter case, there is a problem in that the service will not work well unless histories of a large number of users are provided. That is to say, it is necessary to clarify relationships themselves among items across a plurality of fields by the histories of a large number of users.

On the other hand, there is a technique in which when a certain content, such as a television program, etc., is selected, an item whose meta data includes the same keyword as a keyword included in the content is recommended as a related content. By this technique, for example, when a user selects a certain television program, a DVD (Digital Versatile Disc) including a movie, in which the same performer appears as a performer in that television program, is recommended.

There is a problem with this technique. For example, if there is no content including a matched keyword, it is difficult to recommend the related contents.

The present invention has been made in view of these circumstances. It is desirable to obtain relationships among items on the basis of a user's evaluation, and to recommend an item across fields.

According to an embodiment of the present invention, there is provided an information processing apparatus including: analysis means obtaining a relationship between items pertaining to individually different fields on the basis of a user's evaluation on the individual items; setting means setting relationship information being information indicating the relationship obtained by an analysis of the analysis means for individual items as meta data; and on the basis of the relationship information set by the setting means for a predetermined item to be a reference, recommendation means identifying, as a recommendation item, an item pertaining to a different field from a field including the predetermined item having a relationship with the predetermined item.

The above-described information processing apparatus may further include item identification means identifying an item being similar to a new item whose relationship with another item is not obtained, the item whose relationship with another item is obtained, on the basis of coincidence of meta data other than the relationship information. In this case, the setting means may further set for the new item, as meta data, the relationship information indicating a relationship with the other item related to the item identified to be similar to the new item by the item identification means.

The above-described information processing apparatus may further include group identification means identifying a user group including a plurality of users having similar evaluations on a same item. In this case, the analysis means may obtain a relationship between items for each group identified by the group identification means on the basis of the evaluations on the individual items by users pertaining to individual group, and the setting means may set for individual items, as meta data, the relationship information indicating a relationship obtained for each group by an analysis by the analysis means.

In the above-described information processing apparatus, the recommendation means may identify the recommendation item on the basis of the relationship information obtained as information of the group, identified by the group identification means, including a user who is going to receive recommendation of an item.

According to another embodiment of the present invention, there is provided a method or a program of processing information, the method or a program including the steps of: obtaining a relationship between items pertaining to individually different fields on the basis of a user's evaluation on the individual items; setting relationship information being information indicating the obtained relationship for individual items as meta data; and on the basis of the relationship information set for a predetermined item to be a reference, identifying, as a recommendation item, an item pertaining to a different field from a field including the predetermined item having a relationship with the predetermined item.

By an embodiment of the present invention, a relationship between items pertaining to individually different fields is obtained on the basis of a user's evaluation on the individual items. The relationship information, which is the information indicating the obtained relationship, is set for individual items as meta data. Also, on the basis of the relationship information set for a predetermined item to be a reference, as a recommendation item, an item pertaining to a different field from a field including the predetermined item having a relationship with the predetermined item is identified.

By an embodiment of the present invention, it is possible to obtain relationships among items on the basis of a user's evaluation, and to recommend an item across fields.

### BRIEF DESCRIPTION OF THE DRAWINGS

FIG. 1 is a block diagram illustrating an example of a configuration of a recommendation system according to an embodiment of the present invention;

FIG. 2 is a diagram illustrating an example of category mapping;

FIG. 3 is a diagram illustrating an example of relationships between categories;

FIG. 4 is a diagram illustrating an example of relationships among categories;

FIG. 5 is a diagram illustrating an example of users' evaluations;

FIG. 6 is a diagram illustrating an example of individual dimension values obtained by compressing dimensions;

FIG. 7 is a diagram illustrating an example of relationships between groups;

FIG. 8 is a diagram illustrating an example of relationships among new items;

FIG. 9 is a flowchart illustrating meta data setting processing in a server;

FIG. 10 is a flowchart illustrating the other meta data setting processing in the server;

FIG. 11 is a flowchart illustrating recommendation processing in the server;

FIG. 12 is a block diagram illustrating another example of a configuration of the recommendation system;

FIG. 13 is a diagram illustrating an example of user types;

FIG. 14 is a diagram illustrating an example of relationship information;

FIG. 15 is a diagram illustrating a state of playing back a television program;

FIG. 16 is a diagram illustrating an example of expression time-series data;

FIG. 17 is a diagram illustrating an example of information to be obtained by a client; and

FIG. 18 is a block diagram illustrating an example of a hardware configuration of a computer.

### DESCRIPTION OF THE PREFERRED EMBODIMENTS

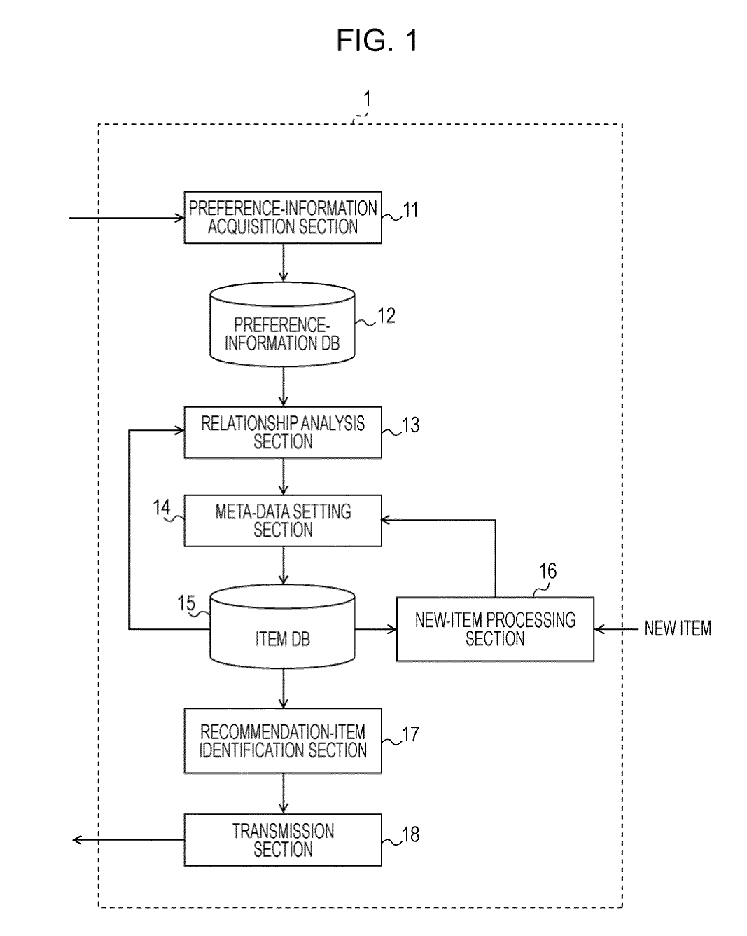

FIG. 1 is a block diagram illustrating an example of a configuration of a recommendation system according to an embodiment of the present invention.

As shown in FIG. 1, the recommendation system is implemented in a server 1.

The server 1 includes a preference-information acquisition section 11, a preference-information DB 12, a relationship analysis section 13, a meta-data setting section 14, an item DB 15, a new-item processing section 16, a recommendation-item identification section 17, and a transmission section 18.

As described below, in the server 1, a relationship between items pertaining to individually different fields is obtained on the basis of a user's evaluation on the items. The information indicating the obtained relationship is set as meta data for the individual items.

Here, the fields include television programs, books, music, games, etc. The items include individual television programs, individual books, such as a weekly magazine, a pocket book, etc., individual pieces of music, such as a music content for down loading, a CD including music contents, etc., and individual games, such as a game content for down loading, a recording medium including game contents, etc.

The set meta data is used to identify an item to be recommended to the user. For example, on the basis of a certain television program selected by the user, an item in the other fields, such as a book, music, etc., which has a relationship with the television program to be a reference is identified as a recommendation item. The recommendation item information is transmitted to a client used by the user who is going to receive recommendation of the item.

That is to say, the server 1 is an apparatus which recommends an item across fields. A plurality of terminals, such as a personal computer, etc., are connected to the server 1 as clients through a network.

The preference-information acquisition section 11 of the server 1 obtains preference information indicating the user's evaluation on the item. For example, after the user of the client watched a television program or read a book, the user inputs an evaluation of the item into the client. The client generates preference information indicating the user's evaluation and which item is evaluated, and the client transmits the information to the server 1. For an item to be evaluated, various meta data, such as a field, a category, a keyword, a selling source, etc., are sampled to be obtained by the server 1.

The preference information may be input by an administrator of the server 1 operating an input device provided for the server 1, such as a mouse, a remote controller, etc.

The preference-information acquisition section 11 obtains the preference information transmitted from a client and the input preference information, and stores the obtained preference information into the preference-information DB 12.

A plurality of clients transmit preference information to the server 1, and the server 1 collects the preference information indicating evaluations on items in a plurality of fields, and stores the information in the preference-information DB 12.

The relationship analysis section 13 reads preference information from the preference-information DB 12, and analyzes the information. The relationship analysis section 13 obtains relationships on items to be referenced for identifying another item using a certain item as a reference, such as among items, among item categories, etc., on the basis of the evaluations of individual users.

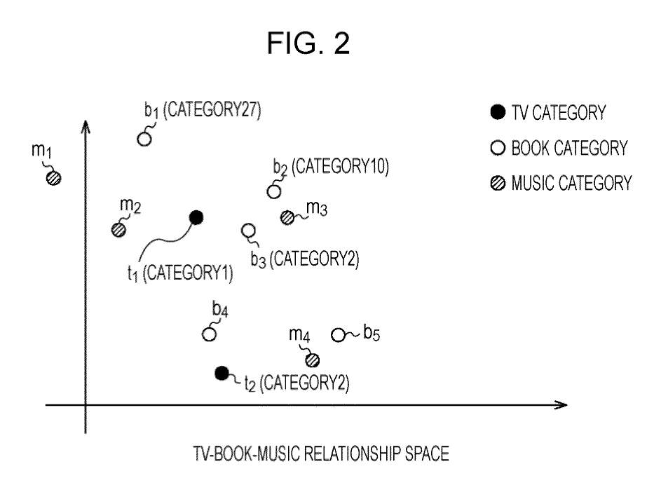

For example, as shown in FIG. 2, the relationship analysis section 13 maps individual categories pertaining to different fields into one space on the basis of the user's evaluations, and obtains relationships among individual categories. If the evaluations are similar, a distance between categories having a relationship in the space becomes short. If the evaluations are not similar, a distance between categories having no relationship in the space becomes long.

The evaluations on categories may be obtained by the server 1 on the basis of the evaluations by the user on the items pertaining to individual categories. Alternatively, the evaluations on the categories may be directly input by the user.

In the example of FIG. 2, points t₁, t₂ represent positions in a space of a television program (TV) category. Points b₁ to b₅ indicate positions in a space of a book category. Points m₁ to m₄ indicate positions in a space of a music category.

For example, the fact that the distance between the point t₁ to the point b₃ is short represents that category1 of the television program whose position is represented by the point t₁ and category2 of the book whose position is represented by the point b₃ are similar in the evaluations of the individual categories or the evaluations on the items pertaining to individual categories.

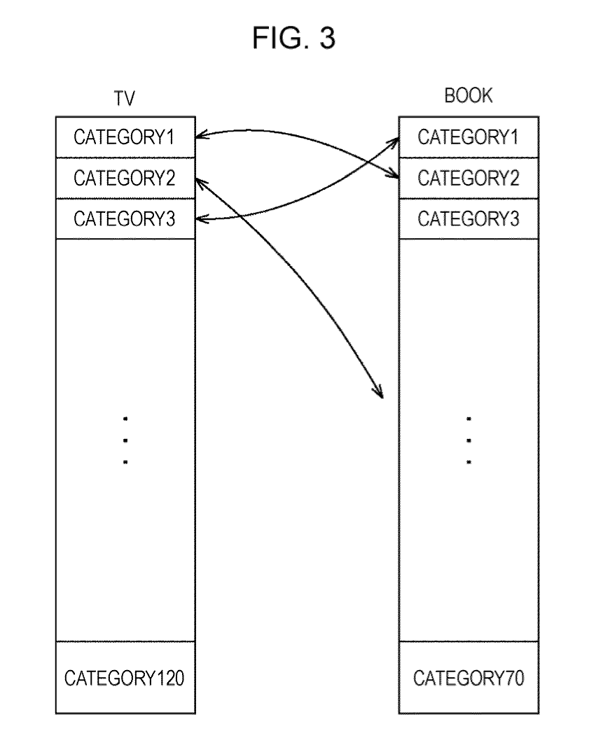

As shown in FIG. 3, the relationship analysis section 13 obtains relationships between individual categories of a certain field, using as a reference, with individual categories in another field. In the example of FIG. 3, there is a relationship between category1 of the television program and category2 of the book, and there is a relationship between category3 of the television program and category1 of the book.

The relationships are obtained not only between the television program and the book, but also between the other fields by the relationship analysis section 13.

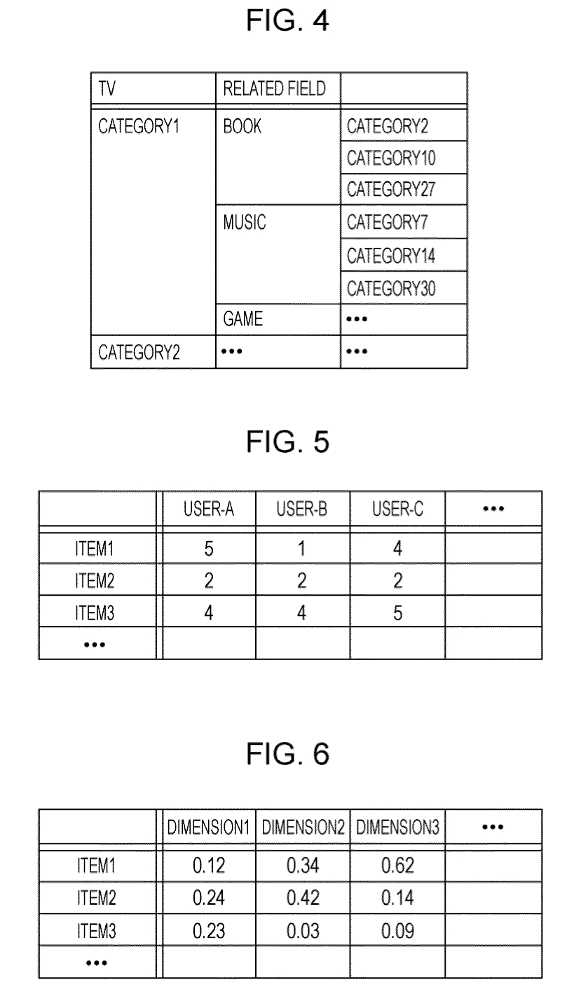

FIG. 4 is a diagram illustrating an example of relationships among categories.

In an example in FIG. 4, the categories having relationships with the category1 of the television program are category2, category10, and category27 of the book, category7, category14, and category30 of the music, and a predetermined category of the game. In the similar manner, for category2 of the television program, the relationships with the categories of the other fields are obtained.

For example, principal component analysis, canonical correlation analysis, or categorical principal component analysis is performed on the user's evaluations in order to obtain scoring points. The above-described relationships are obtained from the obtained scoring points of the items and scoring points of the categories.

FIG. 5 is a diagram illustrating an example of users' evaluations.

In the example in FIG. 5, item1 in a certain field is graded as 5 in five-grade evaluation by user-A, is graded as 1 by user-B, and is graded as 4 by user-C. In the same manner, an item2 is graded as 2 by user-A to user-C. Item3 is graded as 4 by user-A and user-B, and is graded as 5 by user-C.

For example, principal component analysis is performed on such evaluations, and thereby the patterns of similar evaluations are put together to be subjected to dimensional compression. In the example of FIG. 5, the pattern of the evaluations on item1 to item3 by user-A and that of the same evaluations by user-C are similar.

FIG. 6 is a diagram illustrating an example of individual dimension values obtained by performing dimensional compressing on the evaluations in FIG. 5.

In the example of FIG. 6, the values of dimension1, dimension2, and dimension3 of the item1 are 0.12, 0.34, and 0.62, respectively. Such individual dimensional values are obtained by the principal component analysis, and the individual items and the individual categories are mapped to a space having individual dimensions as axes. Thereby, as described with reference to FIG. 2, the distances among individual items and among individual categories are obtained.

The number of dimensions to be analyzed can be an arbitrary number, the number corresponding to one eigenvalue or more, the number immediately before proportion sharply drops, and the number making cumulative proportion a constant value or more.

An eigenvalue corresponds to the variance of a principal component, and represents how much the principal component holds the original information (variate). If the variance of the original variate is standardized as 1, the eigenvalue represents how many times of pieces of information the principal component has compared with the information of the original variate. If an eigenvalue is less than 1, the eigenvalue has information less than the original variate, and thus the principal component becomes meaningless.

The proportion represents the ratio of the amount of information represented by a certain principal component to the amount of all the information. The cumulative proportion is the sum of the proportions of individual principal components in descending order of proportion, and represents the ratio of the information as far as the principal component whose proportion has been added to the original information (in general, the dimensions representing 70 to 80% are adopted).

The canonical correlation analysis used for analyzing a user's evaluation is an analysis method in which a variate (canonical variate) is thought as the sum of the variables added with weights (weighting factors) for each variable group, and a weighting factor which maximizes the correlation (canonical correlation coefficient) between the canonical variates is obtained. In this case, for obtaining a distance in a space, a weighting variable is used instead of using a principal component score.

The categorical principal component analysis is a method of putting together the patterns of similar evaluations to perform analysis in the same manner as the principal component analysis.

The evaluations on the items of all the K fields to be targeted may be analyzed all together. Alternatively, the evaluations on the items of two fields may be selected from the K fields, a relationship between the two fields may be obtained, and these operations may be executed for the number of combinations. Thereby, the relationships of the items of all the K fields may be analyzed.

In the former case, for example, if fields to be targeted are three fields, namely, a television program, a book, and music, the evaluations of all the items of the individual fields are put together to be analyzed, and the individual items are mapped into one space as shown in FIG. 2. The obtained principal component score of each item is used as coordinates indicating a position in an integrated space. In this case, the items of all the fields can be mapped into one space, and thus it becomes possible to obtain a relationship between items in one space.

In the latter case, for example, if the targeted fields are four fields, namely, a television program, a book, music, and a movie, evaluations on the items are selected by the combinations of these fields, namely, a television program and a book, a television program and music, a television program and a movie, a book and music, a book and a movie, and music and a movie. The analysis is carried out on the selected evaluations.

An analysis is made on the evaluation of each item of television programs and the evaluation of each item of books, and the relationship between a television program item and a book item is obtained from a television-program versus book relationship space obtained by mapping each item. An analysis is made on the evaluation of each item of television programs and the evaluation of each item of music, and the relationship between a television program item and a music item is obtained from a television-program versus music relationship space obtained by mapping each item.

In the same manner, a relationship between a television program item and a movie item, a relationship between a book item and a music item, a relationship between a book item and a movie item, and a relationship between a music item and a movie item are individually obtained.

In this regard, when relationships between categories are obtained as shown in FIG. 3, the categories of the individual fields may be classified into a predetermined number of groups, and the relationships among the groups may be obtained.

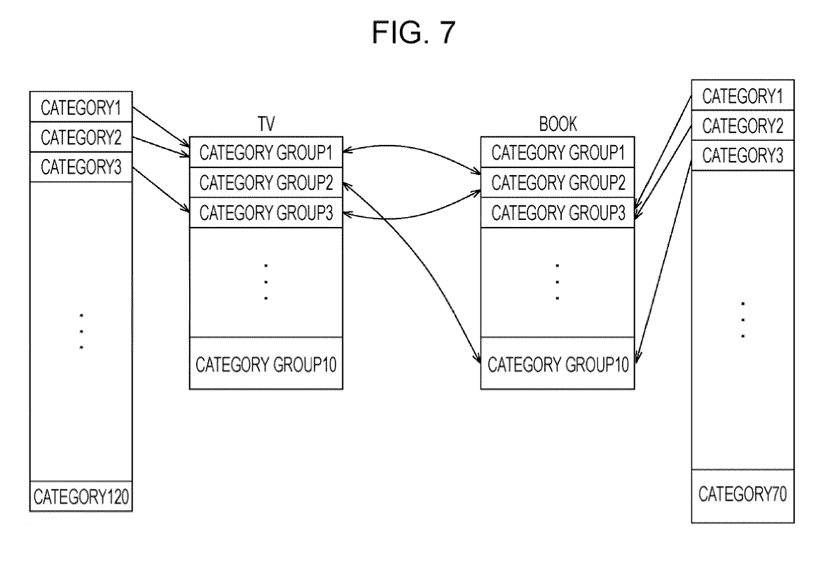

FIG. 7 is a diagram illustrating an example of the case of obtaining relationships among groups.

In the example of FIG. 7, category1 and category2 of the television program are classified into category group1. The other categories of the television program are classified into a predetermined category group in the same manner.

At the same time, category1 and category2 of the book is classified into category group3. The other categories of the book are classified into a predetermined category group in the same manner. The classification (clustering) of category groups is identified on the basis of the correlation value of the evaluations on individual categories.

The relationship between the category groups classified in this manner is obtained by the principal component analysis and the canonical correlation analysis described above. As shown in FIG. 7, category group2 of the book is identified as a category group related to category group1 of the television program. Also, category group10 of the book is identified as a category group related to category group2 of the television program. Category group2 of the book is identified as a category group related to category group3 of the television program.

The information representing the relationships obtained as described above is supplied from the relationship analysis section 13 to the meta-data setting section 14.

The meta-data setting section 14 sets the relationship information, which is information representing relationships obtained by the relationship analysis section 13 as meta data of each item, and stores the information into the item DB 15. When information representing relationships among categories are set for an item as meta data, information, such as shown in FIG. 4, representing categories of the other fields related to the category of that item is set.

Also, the meta-data setting section 14 sets relationship information representing relationships obtained by the new-item processing section 16 as meta data of a new item, and stores the information into the item DB 15.

When information on a new item whose evaluation by the user has not been obtained is input, the new-item processing section 16 identifies an item, similar to the new item, whose relationship has already been obtained on the basis of the meta data other than the relationship information. For example, the new-item processing section 16 obtains the coincidence between the meta data of the new item and the meta data, stored in the item DB 15, of each item whose relationship has been already obtained. The new-item processing section 16 identifies the item having a greatest coincidence out of the items whose relationships are already obtained as an item similar to the new item.

In the case where meta data from which a coincidence is obtained is of high density, such as a category, a cosine distance or an inner product is obtained, and the obtained value is used as a coincidence. The kinds of category as meta data are limited, and if a sufficiently large number of items are divided into categories, items pertaining to a same category are relatively often found, and thus a category is said to be high-density meta data.

On the other hand, in the case of meta data from which a coincidence is obtained is of low density, such as a keyword, a sentence, etc., dimension compression is performed by, such as PLSA (Probabilistic Latent Semantic Analysis), LDA (Linear Discriminant Analysis), or the like, and then a distance is obtained to be used for a coincidence. There are many kinds of keywords and sentences. Thus, if a sufficiently large number of items are divided into item groups having a same keyword or a same sentence as meta data, items having a same keyword or a same sentence as meta data are rarely found, and thus a keyword or a sentence is said to be low-density meta data.

Also, when a relationship between items that have been evaluated by the user is obtained, the new-item processing section 16 maps the new item onto the same position in space with an item identified to be similar to the new item, and obtains an item, which has a relationship with the new item, in the other fields. The new-item processing section 16 outputs the obtained item information to the meta-data setting section 14.

That is to say, for a new item, the same relationship information as the relationship information set in an item, similar to the new item and whose relationship has been already obtained, is set as meta data.

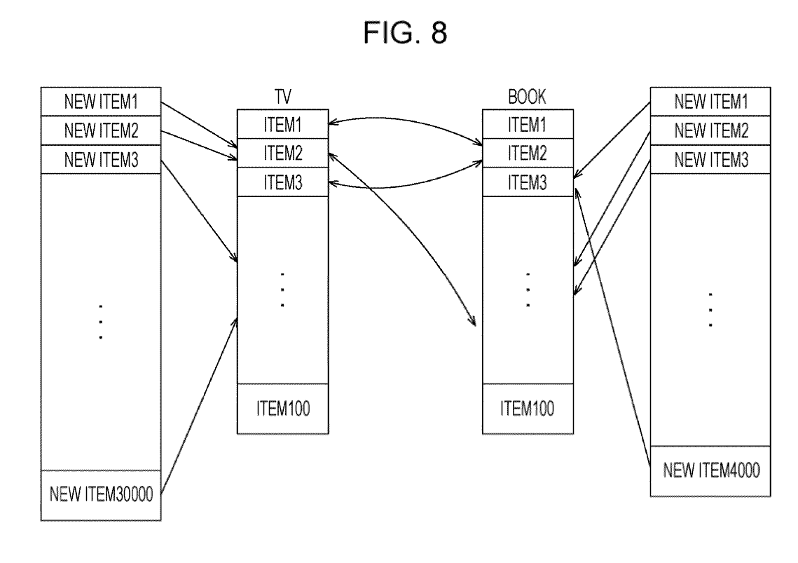

FIG. 8 is a diagram illustrating an example of relationships among new items.

FIG. 8 shows an example of the case where information of new item1 to item30000, which are new items of the television program, and information of new item1 to item4000, which are new items of the book, are input.

In the example of FIG. 8, item2 is assumed to be an item of the television program that already has a relationship with an item of the other field, which is similar to new item1 and new item2 of the television program. In this case, relationship information indicating that there is a relationship with an item of the book related to item2 of the television program is set in new item1 and new item2 of the television program as met data.

At the same time, an item 3 is assumed to be an item that already has a relationship with an item of the other field, which is similar to new item1 and new item4000 of the book. In this case, relationship information indicating that there is a relationship with an item related to item3 of the book is set in new item1 and new item4000 of the book as met data.

Referring back to description of FIG. 1, the recommendation-item identification section 17 identifies an item in the other field related to a reference item on the basis of the meta data of each item stored in the item DB 15. For example, a recommendation item is identified on the basis of one item selected by the user to receive recommendation.

In this regard, when information indicating a relationship between the categories is set, an item of the other category related to the category of an item to be a reference is identified as a recommendation item.

The recommendation-item identification section 17 reads information, such as a title of the recommendation item, a selling source, etc., from the item DB 15, and outputs such information that has been read to the transmission section 18.

The transmission section 18 transmits the information supplied from the recommendation-item identification section 17 to a client used by the user who receive a recommendation through a network such as the Internet. The client which has received the information transmitted from the transmission section 18 presents the information on the recommendation item to the user.

Here, a description will be given of the processing of the server 1 having the above-described configuration.

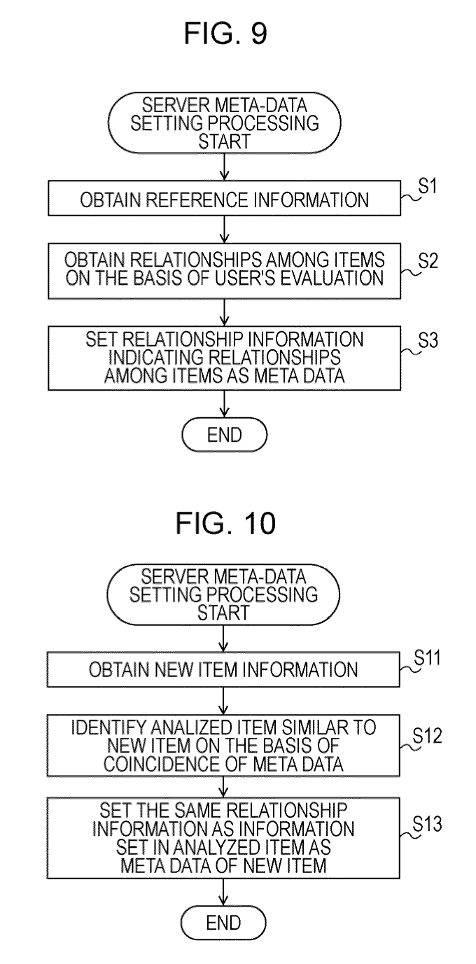

First, a description will be given of the processing of the server 1 for setting meta data with reference to FIG. 9. Here, an item for which relationship information is set is assumed not to be a new item, but assumed to be an item which has been subjected to the user's evaluation.

In step S1, the preference-information acquisition section 11 obtains preference information indicating the user's evaluations on items, and stores the obtained information into the preference-information DB 12.

In step S2, the relationship analysis section 13 reads the preference information from the preference-information DB 12 to analyze the information, and obtains relationships between items on the basis of the individual user's evaluations. In the case of obtaining relationships among categories, in the same manner, an analysis is made on the basis of the evaluations of the individual categories obtained from the user's evaluation and the individual category evaluations input by the user.

In step S3, the meta-data setting section 14 sets the relationship information indicating the relationship obtained by the relationship analysis section 13 as meta data, and stores the information into the item DB 15. After that, the processing is terminated.

Each time preference information is acquired, the above-described processing is performed as pre-processing before recommending an item. Thus, relationship information is set for individual items of a plurality of fields.

Next, a description will be given of the other processing of the server 1 setting meta data with reference to a flowchart in FIG. 10. Here, an item for which relationship information is set is assumed to be a new item.

In step S11, the new-item processing section 16 obtains information of a new item whose evaluation by the user has not been obtained. The information to be obtained includes mate data of the new item.

In step S12, the new-item processing section 16 identifies an item which is similar to the new item and whose relationship has been analyzed on the basis of the coincidence of meta data. Also, the new-item processing section 16 maps the new item onto a position in the same space with the identified item in order to obtain an item in the other field and having a relationship with the new item.

In step S13, the meta-data setting section 14 sets the same relationship information as the relationship information set in the item, which is similar to the new item and whose relationship has been analyzed, obtained by the new-item processing section 16 as the meta data of the new item, and stores the information into the item DB 15. After that, the processing is terminated.

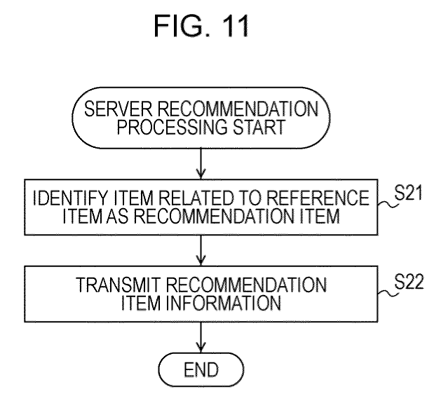

Next, a description will be given of the processing of the server 1, which recommends an item, with reference to a flowchart in FIG. 11. This processing is started, for example, when an item to be a reference is selected by the user of a client.

In step S21, the recommendation-item identification section 17 identifies an item in the other fields and having a relationship with the item to be a reference as a recommendation item on the basis of the meta data of each item stored in the item DB 15. The recommendation-item identification section 17 outputs the information on the recommendation item to the transmission section 18.

In step S22, the transmission section 18 transmits the information supplied from the recommendation-item identification section 17 to the client, and terminates the processing. After that, the processing is terminated.

The above-described processing is performed each time an item to be a reference is selected, and thereby a recommendation item is presented to the user in sequence. The user selects a recommendation item being displayed one after another as a reference item, and thereby the user can confirm an item one after another, in another field, having a relationship with the selected recommendation item.

By the above-described processing, the server 1 can obtain relationships among items on the basis of the user's evaluations on the items.

Also, the server 1 can recommend an item across the fields on the basis of the obtained relationships.

A selection history of the user on a certain field may be stored as a profile, and the relationship information may be used for predicting a profile for items in another field.

In this case, for example, each time an item is selected in the field of the television program, information of the items in the other fields, such as the book, the game, etc., which have a relationship with the selected each item, is stored for each field, and the stored information of the items in the other fields is used as a profile of the user for the field.

Specifically, if television program1 and book1, television program2 and book 2, and television program3 and book3 are the individual pair of items having relationships, when television program1, television program2, and television program3 are selected in sequence, information of book1, book2, and book3 are stored in sequence, and the information is used for a profile of the user in the book field.

The items in the book field, whose information has been stored, have relationships with the items actually selected by the user in the television-program field. Thus, it becomes possible to predict a profile in the book field, which is one of the other fields, from the profile in the television-program field in this manner.

The profile predicted in this manner may be used by being directly presented to the user, or may be used for identifying a recommendation item.

For example, if the user selects book1 in the book field, book2 having a relationship with television program2, which has been selected in the second place in the television-program field, is identified as a recommendation item.

Thereby, even if the user's selection history is obtained only in a specific field, it is possible to predict the user's preference (profile) in the other fields, and to recommend an item. This means that it is possible to recommend an item without having a large amount of user data.

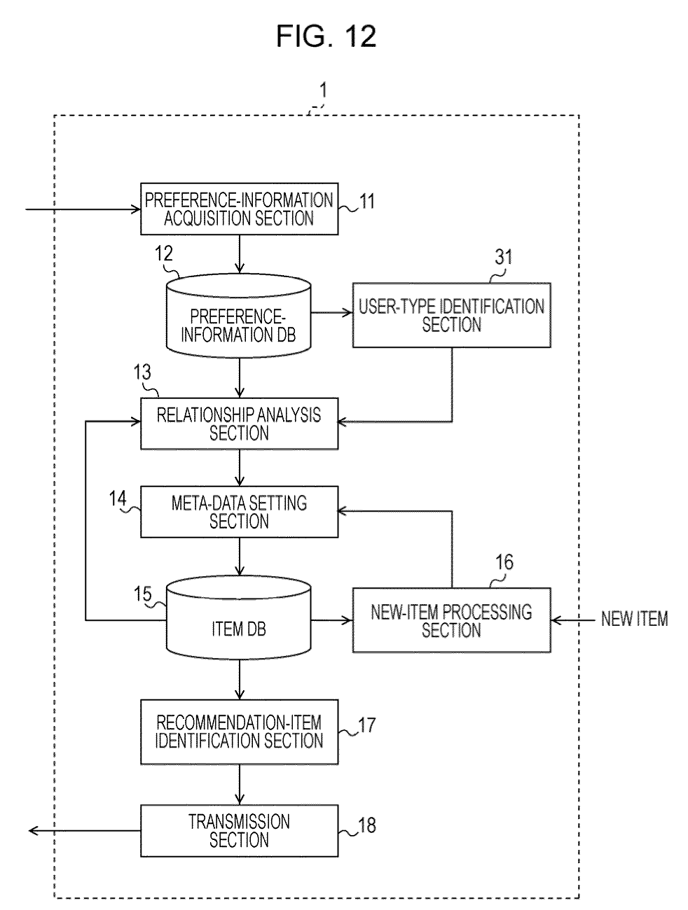

FIG. 12 is a block diagram illustrating another example of a configuration of the recommendation system. In the configuration shown in FIG. 12, the same reference numerals are given to the same components as those shown in FIG. 1. A duplicated description will be appropriately omitted.

The configuration of the server 1 shown in FIG. 12 is different from the configuration of the server 1 in FIG. 1 in the point that it is further provided with a user-type identification section 31.

The user-type identification section 31 divides the users having evaluated items on the basis of the preference information stored in the preference information DB 12 into groups, and identifies a group (type) to which each user belongs.

The user-type identification section 31 performs, for example, principal component analysis on the user's evaluations of individual items and categories, and identifies each user type by clustering the users on the basis of the result of the analysis.

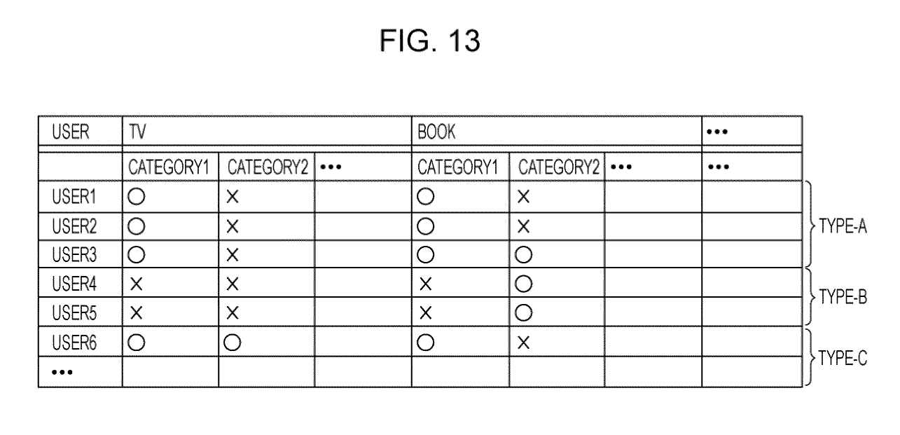

FIG. 13 is a diagram illustrating an example of user types.

FIG. 13 shows evaluations, by user1 to user6, of individual categories of the television program, and individual categories of the book. In this figure, a white circle indicates a high evaluation, and a cross indicates a low evaluation.

In the case where the evaluations as shown in FIG. 13 has been obtained from the user1 to user6, and principal component analysis, etc., is performed on the evaluations, the type of user1 to user3 is identified as a same type-A, because the evaluations by user1 to user3 are similar to one another.

In the same manner, the type of user4 and user5 is identified as a same type B, because the evaluations by user4 and user5 are similar to each other. The type of user6 is identified as a same type-C together with the other users having similar evaluations.

The user-type identification section 31 outputs information indicating a type of the users identified in this manner to the relationship analysis section 13.

The relationship analysis section 13 obtains the relationships among items and among categories for each user type on the basis of the evaluations by the users pertaining to the same type as described above, and outputs information indicating the obtained relationships to the meta-data setting section 14.

The meta-data setting section 14 sets the relationship information indicating a relationship for each type, which has been supplied from the relationship analysis section 13, and stores the information in the item DB 15.

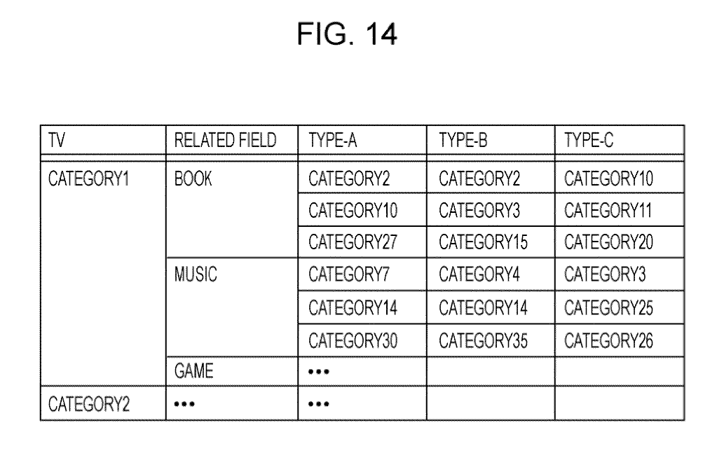

FIG. 14 is a diagram illustrating an example of relationship information.

In an example in FIG. 14, categories of the book having a relationship with category1 of the television program are category2, category10, and category27 for the type-A users, category2, category3, and category15 for the type-B users, and category10, category11, and category20 for the type-C users. Also, categories of the music having a relationship with category1 of the television program are category7, category14, and category30 for the type-A users, category4, category14, and category35 for the type-B users, and category3, category25, and category26 for the type-C users.

For the items in category1 of the television program, such a plurality of pieces of the relationship information to be targeted for the individual type users are set as meta data.

When recommendation of items is performed using such relationship information, first, the type of a user who receives a recommendation is identified. After that, the identification of recommendation items, etc., are performed using the relationship information for the users of the identified type.

Thus, the server 1 can obtain relationships among items in consideration of the difference in the user's preference. Also, the server 1 can recommend an item corresponding to the user's preference on the basis of the relationships obtained in such a way.

It is also possible to use the relationship information for each type for weight learning of CBF (Content Based Filtering).

In this case, when an item, in the other fields, having a relationship with an item to be a reference is presented to the user as a recommendation item, a recommendation item for each type is presented, for example, a recommendation item for the type-A users, a recommendation item for the type-B users, and a recommendation item for the type-C users.

Each time a predetermined recommendation item is selected from the presented items, the server 1 stores a history of item selections by the user. The learning is performed which type of relationship the user follows on the basis of the stored history. For example, if identified that the user selects an item by following a relationship of type-A, a heavy weight is set for the meta data of the item having a relationship for the type-A users in order for the items having relationships for the type-A users to be easily selected as recommendation items.

The weighting may be performed every time the history is updated once, or may be performed after the history is stored for a certain period of time. The ratio of histories may be reflected on how to increase the weight. For example, if it is identified that the case of selecting an item in accordance with the relationship for the type-A users is more often than the case of selecting an item in accordance with the relationship for the type-B users, a weight having a larger amount of increase is set for an item having a relationship with the type-A users.

When a plurality of types of items are presented, the items may be presented in descending order of weight given to the type of the items. Alternatively, if there is a certain difference or more between the weight set for the type-A and the weight set for the type-B, the item of the type-B may not be presented. This means that an item of the type having a low weight with a certain difference or more may not be presented.

In the above, it is assumed that a five-grade evaluation input by the user is used for information for obtaining relationships among items. However, the same processing may be performed on the basis of a time-series data pattern of expressions shown by the user while viewing an item.

Here, the expression means the user's reaction recognizable by an image or sound from the outside, for example, a facial expression such as a laughing face, frowning, etc., a speech such as talking to oneself, a dialog, etc., an action, such as clapping hands, a nervous jiggling of the legs, tapping, etc., a posture such as resting elbows, leaning upper body, etc.

That is to say, in the client used by the user who receives item recommendation from the server 1, a plurality of kinds of the expressions shown by the user are detected at predetermined intervals on the basis of the image obtained by shooting the user who is watching an item, or the user's sound obtained by picking up sound while the item is played back.

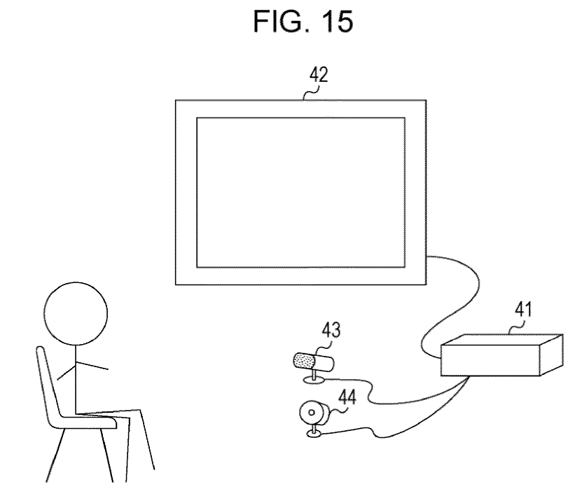

FIG. 15 is a diagram illustrating a state of playing back a television program as an item.

In an example in FIG. 15, a television receiver 42, a microphone 43, and a camera 44 are connected to a client 41. The directivity of the microphone 43 and the shooting range of the camera 44 are toward the user of the client 41, who watches an item while sitting on a chair in front of the television receiver 42.

The user's sound picked up by the microphone 43 while the item is played back, and the image of the user taken by the camera 44 are supplied to the client 41.

For example, on the above-described laughing face, the range of the user's face is detected from the image captured by the camera 44, and detection is made by matching the characteristic of the detected face and the characteristic of a laughing face provided in advance. The client 41 obtains time-series data indicating timing when the user has turned into a laughing face and a degree of laughter (a burst of laughter, smile, etc.).

In the same manner, on frowning, the range of the user's face of is detected from the image captured by the camera 44, and detection is made by matching the characteristic of the detected face and the characteristic of a frowning face provided in advance. The client 41 obtains time-series data indicating timing when the user has turned into frowning and a degree of frowning.

For a speech, such as talking to oneself, a dialog, etc., sound is picked up using the microphone 43, and a speaker of the sound is identified by speaker recognition. The picked-up sound is detected by being recognized whether the sound is a talk to oneself by the user of the client or a dialog with the other users watching the item together. The client 41 obtains time-series data indicating timing of the user's speech and a sound volume, which is a degree of the speech.

Clapping hands is detected on the basis of the sound picked up by the microphone 43. The client 41 obtains time-series data indicating timing of the user's clapping hands, and a degree, such as the strength of the clapping.

In the same manner, the other expressions are detected on the basis of the data obtained by the microphone 43 and the camera 44. The data obtained by the microphone 43 and the camera 44 may be recorded once into a recording medium, such as a hard disk. Then, the recorded data may be subjected to the expression detection. Alternatively, the expressions may be detected in real time each time the data is supplied from the microphone 43 and the camera 44.

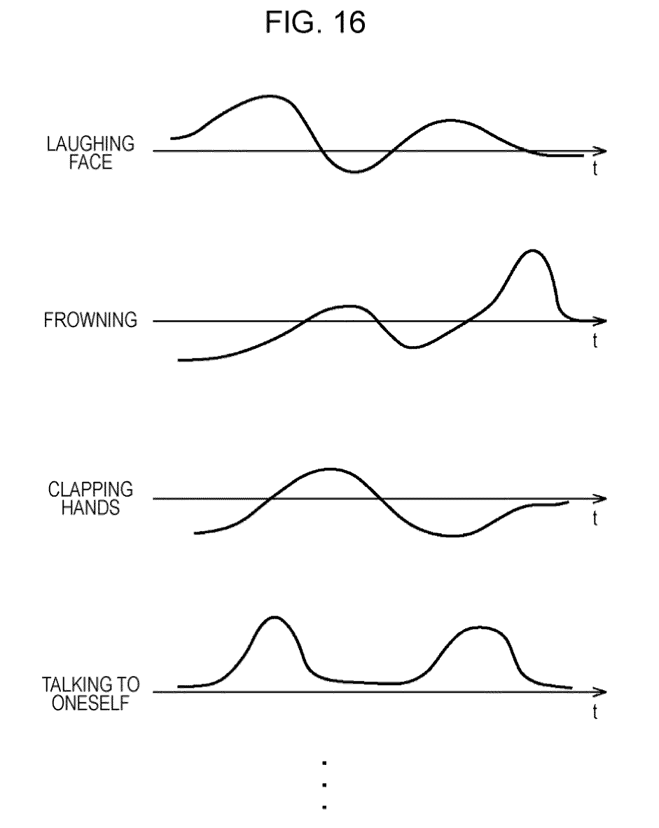

FIG. 16 is a diagram illustrating an example of expression time-series data.

FIG. 16 illustrates time-series data of a laughing face, frowning, clapping hands, and talking to oneself, each of which is listed in this order from top. The horizontal axis shows time, and the vertical axis shows a degree.

The client 41 plays back a plurality of items, and obtains time-series data as shown in FIG. 16 for each played-back item. The user inputs evaluations on individual items. The client 41 obtains the user's evaluations on the plurality of items played back individually, and the expression information, which is the expression time-series data obtained while the item is played back.

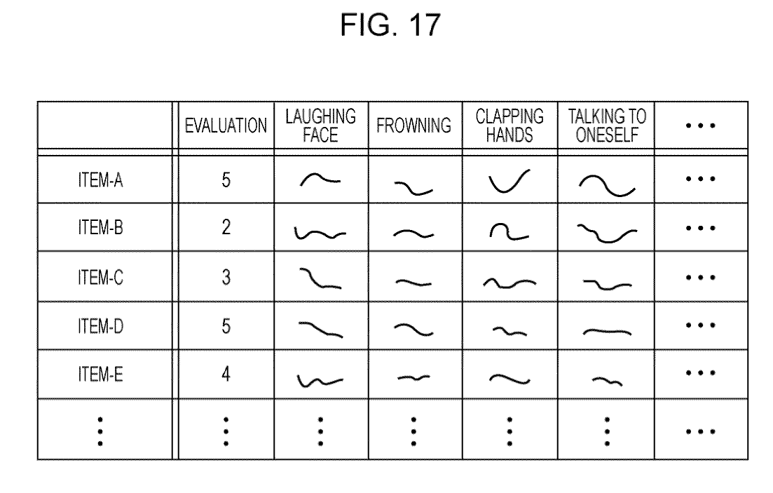

FIG. 17 is a diagram illustrating an example of information obtained by a client 41.

In the example in FIG. 17, evaluation on an item is carried out by a five-grade evaluation. A digit expressing an evaluation is given to each item. Here, 5 indicates the highest evaluation, and 1 indicates the lowest evaluation.

The evaluation on item-A is 5. The evaluation and the time-series data of a laughing face, frowning, clapping hands, and talking to oneself, which have been detected during the playback of item-A, are stored with having a relationship.

The evaluation on item-B is 2. The evaluation and the time-series data of a laughing face, frowning, clapping hands, and talking to oneself, which have been detected during the playback of item-B, are stored with having a relationship. In the same manner for item-C, item-D, and item-E, individual evaluations and the time-series data of the expressions detected during the playback are stored with having relationships.

The client 41 identifies a characteristic expression of an item having a high evaluation on the basis of the information as shown in FIG. 17, and the identified expression is used for the expression of a high-evaluation index. For example, attention is given to the expression information of an item which has been graded as 5 in five-grade evaluation. The identification is conducted on the expressions more often included remarkably in the noticed expression information compared with the expression information of the item having an evaluation other than 5.

It is thought that the expression at the time of watching an interesting item is different for an individual user. For example, a certain user often laughs when watching an item that is felt to be interesting (highly evaluated). Another user often claps hands when watching an item that is felt to be interesting. Here, the user of the client 41 is related to the expression that is output by the user of the client 41 when watching an item that is felt to be interesting.

Specifically, the expression time-series data of N kinds for all items are individually normalized (z-transformed), and the representative values of individual expressions are obtained. For a representative value, for example, a maximum value of degree, a value representing a frequency from which a constant value or more has been detected to be a threshold value, a value representing time during which a constant value or more to be a threshold value has been continuously detected, etc., are obtained from the individual expression time-series data obtained by the normalization.

Also, a comparison is made between individual expression representative value obtained from the expression information of highly-evaluated items and individual expression representative value obtained from the expression information of not highly-evaluated items. The expression, from which a representative value having a definite difference has been obtained, is identified from the expression information of the highly-evaluated items. For a determination of a definite difference, a criterion, such as having a difference of a specific ratio or more, such as a statistical significant difference, a value of 20% or more, etc., can be used.

In the case of FIG. 17, for each item of the items A to E, a representative value of the time-series data of a laughing face, a representative value of the time-series data of frowning, a representative value of the time-series data of clapping hands, and a representative value of the time-series data of talking to oneself are obtained.

Also, among representative values obtained from the expression time-series data of the item A and the item D, which are highly-evaluated items, a representative value having a definite difference from the representative value is obtained from the expression time-series data of the items B, C, and E. The expression having the representative value is identified as the expression of the highly-evaluated index.

The expression to be identified as a highly-evaluated index may be one kind, or may be a plurality of kinds. Also, the expression may not be identified by comparing the representative values obtained from the time-series data. The time-series pattern may be handled as a change pattern, and mining the time-series pattern may be carried out to identify the expression of a highly-evaluated index. For mining a time-series pattern, for example, a description has been given in “E. Keogh and S. Kasetty, “On the Need for Time Series Data Mining Benchmarks: A Survey and Empirical Demonstration”, Data Mining and Knowledge Discovery, vol. 7, pp. 349-371 (2003)”.

The expression information of a highly-evaluated index identified as described above is transmitted from the client 41 to the server 1, and is used for obtaining relationships among the items in place of the user's evaluations on individual items. That is to say, the server 1 performs the principal component analysis as described above, etc., on the expression information.

The identification of such an expression of a high-evaluation index may be performed by the server 1.

The above-described series of processing can be executed by hardware or can be executed by software. When the series of processing is executed by software, the programs constituting the software are built in a dedicated hardware of a computer. Alternatively, the various programs are installed, for example in a general-purpose personal computer capable of executing various functions from a program recording medium.

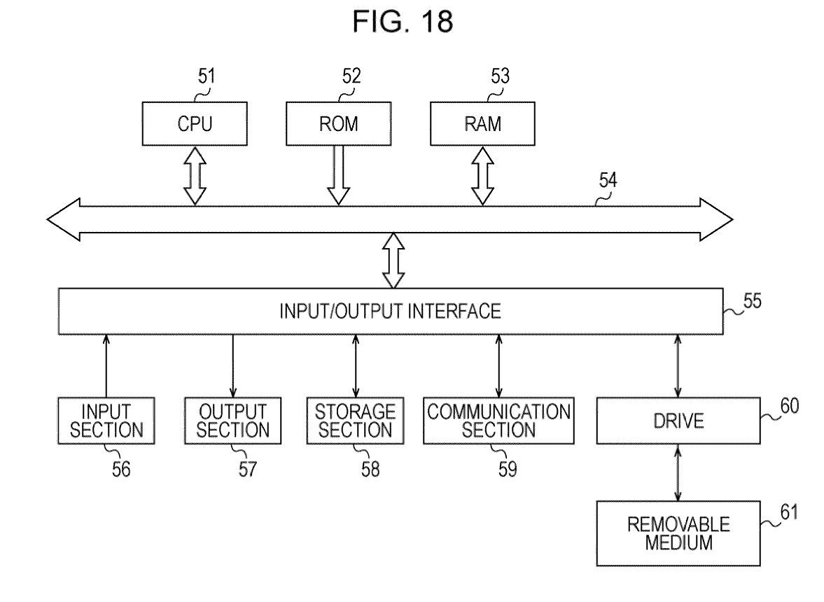

FIG. 18 is a block diagram illustrating an example of a configuration of computer hardware performing the above-described series of processing.

A CPU (Central Processing Unit) 51, a ROM (Read Only Memory) 52, and a RAM (Random Access Memory) 53 are mutually connected by a bus 54.

An input/output interface 55 is also connected to the bus 54. An input section 56 including a keyboard, a mouse, a microphone, etc., an output section 57 including a display, a speaker, etc., a storage section 58 including a hard disk, a nonvolatile memory, etc., a communication section 59 including a network interface, etc., and a drive 60 for driving a removable medium 61, such as an optical disc, a semiconductor memory, etc., are connected to the input/output interface 55.

In the computer having the configuration as described above, the CPU 51 loads the program stored, for example, in storage section 58 to the RAM 53 through the input/output interface 55 and the bus 54 to execute the program, thereby the above-described series of processing is performed.

The program performed by the CPU 51 is recorded, for example, in the removable medium 61. Alternatively, the programs is provided through a wired or wireless transmission medium, such as a local area network, the Internet, digital broadcasting, etc., and is installed in the storage section 58.

In this regard, the programs executed by the computer may be programs that are processed in time series in accordance with the sequence described in this specification. Also, the programs may be the programs to be executed in parallel or at necessary timing, such as at the time of being called, or the like.

An embodiment of the present invention is not limited to the above-described embodiments, and various modifications are possible without departing from the spirit of the present invention.

What is claimed is:

1. An information processing apparatus comprising:
analysis means obtaining a relationship between items pertaining to individually different fields on the basis of a user's evaluation on the individual items;
setting means setting relationship information being information indicating the relationship obtained by an analysis of the analysis means for individual items as meta data; and
on the basis of the relationship information set by the setting means for a predetermined item to be a reference, recommendation means identifying, as a recommendation item, an item pertaining to a different field from a field including the predetermined item having a relationship with the predetermined item.

2. The information processing apparatus according to claim 1, further comprising item identification means identifying an item being similar to a new item whose relationship with another item is not obtained, the item whose relationship with another item is obtained, on the basis of coincidence of meta data other than the relationship information,
wherein the setting means further sets for the new item, as meta data, the relationship information indicating a relationship with the other item related to the item identified to be similar to the new item by the item identification means.

3. The information processing apparatus according to claim 1, further comprising group identification means identifying a user group including a plurality of users having similar evaluations on a same item,
wherein the analysis means obtains a relationship between items for each group identified by the group identification means on the basis of the evaluations on the individual items by users pertaining to individual group, and
the setting means sets for the individual items, as meta data, the relationship information indicating a relationship obtained for each group by an analysis by the analysis means.

4. The information processing apparatus according to claim 3,
wherein the recommendation means identifies the recommendation item on the basis of the relationship information obtained as information of the group, identified by the group identification means, including a user who is going to receive recommendation of an item.

5. A method of processing information, comprising the steps of:
obtaining a relationship between items pertaining to individually different fields on the basis of a user's evaluation on the individual items;
setting relationship information being information indicating the obtained relationship for individual items as meta data; and
on the basis of the relationship information set for a predetermined item to be a reference, identifying, as a recommendation item, an item pertaining to a different field from a field including the predetermined item having a relationship with the predetermined item.

6. A program for causing a computer to perform processing, comprising the steps of:
obtaining a relationship between items pertaining to individually different fields on the basis of a user's evaluation on the individual items;
setting relationship information being information indicating the obtained relationship for individual items as meta data; and
on the basis of the relationship information set for a predetermined item to be a reference, identifying, as a recommendation item, an item pertaining to a different field from a field including the predetermined item having a relationship with the predetermined item.

7. An information processing apparatus comprising:
an analysis mechanism obtaining a relationship between items pertaining to individually different fields on the basis of a user's evaluation on the individual items;
a setting mechanism setting relationship information being information indicating the relationship obtained by an analysis of the analysis mechanism for individual items as meta data; and
on the basis of the relationship information set by the setting mechanism for a predetermined item to be a reference, a recommendation mechanism identifying, as a recommendation item, an item pertaining to a different field from a field including the predetermined item having a relationship with the predetermined item.
